(19) United States
(12) Patent Application Publication
(10) Pub. No.: US 2025/0263542 A1
(43) Pub. Date: Aug. 21, 2025

(54) COMPOSITION FOR VEHICLE PARTS BASED ON RECYCLED POLYPROPYLENE AND A MOLDED BODY FOR VEHICLE PARTS INCLUDING SAME

(71) Applicants: HYUNDAI MOTOR COMPANY, Seoul (KR); KIA CORPORATION, Seoul (KR); SK Geo Centric Co., Ltd., Seoul (KR); SK Innovation Co., Ltd., Seoul (KR)

(72) Inventors: Hee Joon Lee, Seoul (KR); Ki Tae Kim, Hwaseong-si (KR); Min Ho Choi, Seoul (KR); Hee Eun Lee, Daejeon (KR); Doo Hong Min, Daejeon (KR); Hyun Jung Jung, Daejeon (KR)

(73) Assignees: HYUNDAI MOTOR COMPANY, Seoul (KR); KIA CORPORATION, Seoul (KR); SK Geo Centric Co., Ltd., Seoul (KR); SK Innovation Co., Ltd., Seoul (KR)

(21) Appl. No.: 18/663,964

(22) Filed: May 14, 2024

(30) Foreign Application Priority Data
Feb. 20, 2024 (KR) 10-2024-0024324

(51) Int. Cl. C08L 23/12; B62D 29/02; C08K 3/34

(52) U.S. Cl. CPC C08L 23/12; B62D 29/02; C08K 3/34; C08K 2003/343; C08L 2205/025; C08L 2205/035; C08L 2207/20

(57) ABSTRACT

A composition for vehicle parts based on recycled polypropylene includes: 15 wt % to 55 wt % of recycled polypropylene containing a first filler, a high crystallinity polypropylene, an impact modifier, and a second filler. In particular, the weight ratio of the high crystallinity polypropylene to the impact modifier is in a range of 3:1 to 11:1, the combined weight of the first filler and the second filler is from 20 wt % to 25 wt % based on the total weight of the composition, and the recycled polypropylene has a melt index in a range of 5 g/10 min to 35 g/10 min measured at 230° C. and 21.2 N according to ISO 1133-1.

### CROSS-REFERENCE TO RELATED APPLICATION

This application claims, under 35 U.S.C. § 119(a), the benefit of and priority to Korean Patent Application No. 10-2024-0024324, filed on Feb. 20, 2024, the entire contents of which are incorporated herein by reference.

### BACKGROUND

### (a) Technical Field

The present disclosure relates to a composition for vehicle parts based on recycled polypropylene and a molded body for vehicle parts including the same.

### (b) Background Art

Taking into consideration environment and energy saving in recent automobile industries, technology for lightening and recycling vehicle bodies is being developed. Most materials used in vehicles are metal, and plastic is also contained in a predetermined proportion, and polypropylene, which has good flow properties, is used for injection molding in some parts.

When polypropylene used in these parts is recycled and employed as vehicle parts, certain inorganic materials may be contained therein and some deterioration may occur. Accordingly, even when recycled polypropylene resin is employed, it is necessary to design and develop a composition to achieve properties suitable for specific vehicle parts while minimizing degradation of heat resistance, strength, rigidity, and fuel efficiency characteristics.

The statements in this BACKGROUND section merely provide background information related to the present disclosure and may not constitute prior art.

### SUMMARY OF THE DISCLOSURE

The present disclosure is intended to solve the problems encountered in the related art, and an object of the present disclosure is to provide a composition for vehicle parts containing recycled polypropylene and imparted with appropriate impact strength, heat resistance, rigidity, weight reduction, and moldability, and a molded body for vehicle parts.

The objects of the present disclosure are not limited to the foregoing. The objects of the present disclosure are able to be clearly understood through the following description and to be realized by the means described in the claims and combinations thereof.

In order to accomplish the above object, an aspect of the present disclosure provides a composition for vehicle parts based on recycled polypropylene. The composition includes: 15 wt % to 55 wt % of a recycled polypropylene optionally containing a first filler, a high crystallinity polypropylene, an impact modifier, and a second filler. In particular, the weight ratio of the high crystallinity polypropylene to the impact modifier may be from 3:1 to 11:1, the combined weight of the first filler and the second filler may be from 20 wt % to 25 wt % based on a total weight of the composition, and the recycled polypropylene may have a melt index of from 5 g/10 min to 35 g/10 min measured at 230° C. and 21.2 N (load) according to ISO 1133-1.

In an embodiment, the composition may include 30 wt % to 60 wt % of the high crystallinity polypropylene, 3 wt % to 15 wt % of the impact modifier, and 10 wt % to 25 wt % of the second filler.

In an embodiment, the recycled polypropylene may be derived from a vehicle waste including polypropylene, and the vehicle waste may include a door trim, instrument panel, pillar trim, cowl side, door scuff, wheel guard, rear cover, under cover, transverse trim, crash pad cover, steering column shroud, glove box, air duct, or a combination thereof.

In an embodiment, the recycled polypropylene may include the first filler in an amount of 24 wt % or less, but greater than 0 wt %.

In an embodiment, the recycled polypropylene may have a tensile strength in a range of 18 MPa to 23 MPa measured at 50 mm/min according to ISO 527, a flexural modulus in a range of 1100 MPa to 1500 MPa measured at 2 mm/min according to ISO 178, and IZOD impact strength in a range of 1.0 KJ/m² to 1.8 KJ/m² measured at −10° C. according to ISO 180.

In an embodiment, the high crystallinity polypropylene may have a crystallinity of 50% or more, and may include a high crystallinity polypropylene copolymer, a high crystallinity polypropylene homopolymer, or a combination thereof.

In an embodiment, the high crystallinity polypropylene copolymer may have a melt index in a range of 10 g/10 min to 110 g/10 min measured at 230° C. and 21.2 N according to ISO 1133-1, a heat deflection temperature of 110° C. or higher measured under conditions of 0.45 MPa according to ISO 75, and a flexural modulus in a range of 1600 MPa to 2200 MPa measured at 2 mm/min according to ISO 178.

In an embodiment, the high crystallinity polypropylene homopolymer may have a melt index in a range of 15 g/10 min to 70 g/10 min measured at 230° C. and 21.2 N according to ISO 1133-1, a heat deflection temperature of 120° C. or higher measured under conditions of 0.45 MPa according to ISO 75, and a flexural modulus in a range of 1800 MPa to 2300 MPa measured at 2 mm/min according to ISO 178.

In an embodiment, the high crystallinity polypropylene may include the high crystallinity polypropylene homopolymer and the high crystallinity polypropylene copolymer in a weight ratio of from 1:0.7 to 1:10.

In an embodiment, the impact modifier may include a polyolefin elastomer, and the polyolefin elastomer may have a density of from 0.85 g/cm³ to 0.89 g/cm³ and a melt index of from 0.5 g/10 min to 30 g/10 min measured at 230° C. and 21.2 N according to ISO 1133-1.

In an embodiment, each of the first filler and the second filler may include talc, silica, wollastonite, mica, calcium carbonate, barium sulfate, magnesium oxide, calcium silicate, or a combination thereof.

In an embodiment, the composition may have tensile strength of 25 MPa or more measured at 50 mm/min according to ISO 527, and a flexural modulus of 1800 MPa or more measured at 2 mm/min according to ISO 178.

In an embodiment, the composition may have a density of 1.03 g/cm³ to 1.09 g/cm³.

Another aspect of the present disclosure provides a molded body for vehicle parts based on recycled polypropylene, including the composition described above.

In an embodiment, the molded body may be applied to a radiator upper cover for a vehicle.

### DETAILED DESCRIPTION

The above and other objects, features and advantages of the present disclosure are more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals will refer to the same or like elements. For the sake of clarity of the present disclosure, the dimensions of structures are depicted as being larger than the actual sizes thereof. It is understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It is further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it is understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

### Composition for Vehicle Parts Based on Recycled Polypropylene

An aspect of the present disclosure pertains to a composition for vehicle parts based on recycled polypropylene. The composition includes: 15 wt % to 55 wt % of recycled polypropylene optionally containing a first filler, a high crystallinity polypropylene, an impact modifier, and a second filler. In particular, the weight ratio of the high crystallinity polypropylene to the impact modifier may be from 3:1 to 11:1, the combined weight of the first filler and the second filler may be from 20 wt % to 25 wt % based on the total weight of the composition, and the recycled polypropylene may have a melt index in a range of 5 g/10 min to 35 g/10 min measured at 230° C. and 21.2 N (load) according to ISO 1133-1.

The recycled polypropylene may indicate polypropylene that has been molded one or more times, manufactured into a finished product, and then recovered and recycled.

The recycled polypropylene may be derived from vehicle waste or end-of-life vehicle materials including polypropylene. The vehicle waste may include a door trim, instrument panel, pillar trim, cowl side, door scuff, wheel guard, rear cover, under cover, transverse trim, crash pad cover, steering column shroud, glove box, air duct, or a combination thereof.

In the recycled polypropylene, fillers such as inorganic particles may not be separated during the recycling process, or some thereof may be contained.

The recycled polypropylene may substantially not include or include the first filler, and the recycled polypropylene may include the first filler in an amount of 24 wt % or less, but greater than 0 wt % based on 100 wt % of the recycled polypropylene.

The first filler may include an inorganic material applied during production of recycled polypropylene, and may include talc, silica, wollastonite, mica, calcium carbonate, barium sulfate, magnesium oxide, calcium silicate, or a combination thereof.

The recycled polypropylene may have tensile strength in a range of 18 MPa to 23 MPa measured at 50 mm/min according to ISO 527, a flexural modulus in a range of 1100 MPa to 1500 MPa measured at 2 mm/min according to ISO 178, and IZOD impact strength in a range of 1.0 KJ/m² to 1.8 KJ/m² measured at −10° C. according to ISO 180.

The amount of recycled polypropylene may be from 15 wt % to 55 wt %, or 18 wt % to 52 wt %, based on a total of 100 wt % of the composition. When the amount thereof falls in the above range, it is possible to satisfy properties required for vehicle parts and materials and provide environmental friendliness.

The high crystallinity polypropylene may be so-called new polypropylene and may indicate polypropylene that has never been manufactured into a finished product through a process such as molding, etc.

High crystallinity polypropylene (HCPP) is polypropylene having increased crystallinity, and crystallinity thereof may be 5% higher than that of general polypropylene, and may be from 50% to 95%, or 70% to 90%.

High crystallinity polypropylene may include a high crystallinity polypropylene homopolymer obtained by polymerizing propylene alone, a high crystallinity polypropylene copolymer obtained by introducing another monomer for impact resistance, etc. The polypropylene copolymer may include ethylene-propylene diene monomer (EPDM), ethylene-propylene monomer (EPM), etc., and may include 3 wt % to 20 wt % of an ethylene-derived component.

The high crystallinity polypropylene copolymer may include, for example, Impact HCPP, Yuplene, a brand name.

The high crystallinity polypropylene copolymer may have a melt index in a range of 10 g/10 min to 110 g/10 min measured at 230° C. and 21.2 N according to ISO 1133-1, a heat deflection temperature of from 110° C. to 140° C. measured under conditions of 0.45 MPa according to ISO 75, and a flexural modulus in a range of 1600 MPa to 2200 MPa measured at 2 mm/min according to ISO 178. Such a high crystallinity polypropylene copolymer may contribute to an improvement in heat resistance and mechanical properties of a composition including recycled polypropylene.

Examples of the high crystallinity polypropylene copolymer may include those having a melt index of 5 g/10 min to 20 g/10 min, those having a melt index of 20 g/10 min to 40 g/10 min, and combinations thereof.

The high crystallinity polypropylene copolymer may be included in an amount of 17 wt % or more, or 20 wt % or more, based on the total weight thereof.

The high crystallinity polypropylene homopolymer may include, for example, Homo HCPP, Yuplene, a brand name.

The high crystallinity polypropylene homopolymer may have a melt index of from 15 g/10 min to 70 g/10 min measured at 230° C. and 21.2 N according to ISO 1133-1, a heat deflection temperature of from 120° C. to 140° C. measured under conditions of 0.45 MPa according to ISO 75, and a flexural modulus of from 1800 MPa to 2300 MPa measured at 2 mm/min according to ISO 178. Such a high crystallinity polypropylene homopolymer may contribute to an improvement in heat resistance and mechanical properties of a composition including recycled polypropylene.

The high crystallinity polypropylene may include the high crystallinity polypropylene copolymer alone or in combination with the high crystallinity polypropylene homopolymer. When mixed, the high crystallinity polypropylene homopolymer and the high crystallinity polypropylene copolymer may be included in a weight ratio of from 1:0.5 to 1:10, or from 1:0.7 to 1:8. When the weight ratio thereof falls in the above range, the recycled polypropylene composition may be imparted with good moldability and compatibility while minimizing degradation of the properties thereof.

The impact modifier may include a polyolefin elastomer (POE), and the polyolefin elastomer may have a density in a range of 0.85 g/cm³ to 0.89 g/cm³ and a melt index in a range of 0.5 g/10 min to 30 g/10 min measured at 230° C. and 21.2 N according to ISO 1133-1. When using the polyolefin elastomer, moldability and mechanical properties may be prevented from deteriorating.

The polyolefin elastomer (POE) may include an ethylene-based elastomer, may include a polypropylene-based elastomer, or may include ethylene-butene rubber (EBR), ethylene-octene rubber (EOR), ethylene-propylene diene monomer (EPDM), etc.

The weight ratio of the high crystallinity polypropylene to the impact modifier may be from 3:1 to 11:1. When the weight ratio thereof falls in the above range, IZOD impact strength, heat resistance, and moldability may be attained.

The second filler may include talc, silica, wollastonite, mica, calcium carbonate, barium sulfate, magnesium oxide, calcium silicate, or a combination thereof.

The combined weight of the first filler and the second filler may be 20 wt % to 25 wt %. Within the above weight range, it is possible to prevent rigidity and heat resistance from decreasing, and also to prevent fuel efficiency-related characteristics from deteriorating due to excessive weight of a final product.

The composition for vehicle parts based on recycled polypropylene may include or may be composed of 15 wt % to 55 wt % of the recycled polypropylene, 30 wt % to 60 wt % of the high crystallinity polypropylene, 3 wt % to 15 wt % of the impact modifier, and 10 wt % to 25 wt % of the second filler. The composition for vehicle parts based on recycled polypropylene may satisfy this weight range and ratio between specific components, thereby minimizing degradation of impact strength, heat resistance, moldability, and other mechanical properties, and facilitating application thereof to vehicle parts.

The composition for vehicle parts based on recycled polypropylene may have tensile strength of 25 MPa to 35 MPa measured at 50 mm/min according to ISO 527, and a flexural modulus of 1800 MPa to 2800 MPa measured at 2 mm/min according to ISO 178.

The composition for vehicle parts based on recycled polypropylene may have a melt index in a range of 3 g/10 min to 20 g/10 min, or 5 g/10 min to 12.5 g/10 min, as measured at 230° C. and 21.2 N according to ISO 1133-1.

The composition for vehicle parts based on recycled polypropylene may have flexural strength in a range of 25 MPa to 60 MPa, or 38 MPa to 50 MPa, as measured at 2 mm/min according to ISO 178.

The composition for vehicle parts based on recycled polypropylene may have a heat deflection temperature of from 110° C. to 140° C., or 115° C. to 140° C., as measured under conditions of 0.45 MPa according to ISO 75.

The composition for vehicle parts based on recycled polypropylene may have IZOD impact strength in a range of 3 KJ/m² to 12 KJ/m², or 4 KJ/m² to 11 KJ/m², as measured at 23° C. according to ISO 180.

The composition for vehicle parts based on recycled polypropylene may have IZOD impact strength in a range of 2 KJ/m² to 7 KJ/m², or 2.2 KJ/m² to 6 KJ/m², as measured at −10° C. according to ISO 180.

The composition for vehicle parts based on recycled polypropylene may be prepared by mixing solids and chips including resin components, manufacturing the mixture into pellets using an extruder, adding a second filler, and performing melting, kneading, and extrusion. Injection molding thereof may be conducted using an injection machine under conditions of a cylinder temperature of 220-240° C., a mold temperature of 20-40° C., and a pressure of 300-700 kg/cm².

### Molded Body for Vehicle Parts Based on Recycled Polypropylene

Another aspect of the present disclosure pertains to a molded body for vehicle parts based on recycled polypropylene, including the composition for vehicle parts based on recycled polypropylene described above.

The molded body for vehicle parts based on recycled polypropylene may be produced in various shapes depending on the mold used during molding, and for example, may be manufactured as a radiator upper cover for a vehicle.

A better understanding of the present disclosure may be obtained through the following examples and comparative examples. However, these examples are not to be construed as limiting the technical spirit of the present disclosure.

### Examples and Comparative Examples

The following resin components were kneaded in weight ratios shown in Tables 1 and 2 below using a twin-screw screw extruder with screw length (L)/screw diameter (D)=40 operating at 250 rpm (revolutions per minute) and manufactured into pellets. Talc as a second filler was added to the manufactured pellets in a weight ratio shown in Tables 1 and 2 below, followed by melting, kneading, and injection in an injection machine under conditions of a cylinder temperature of 230° C., a mold temperature of 30° C., and a pressure of 500 kg/cm², thereby producing a specimen.
Recycled PP: Recycled polypropylene including 12 wt % of an inorganic filler (first filler) derived from interior materials of end-of-life vehicles was prepared. This recycled polypropylene had a melt index of 10.5 g/min measured at 230° C. and 21.2 N according to ISO 1133-1.
co-HCPP A: Impact HCPP as a high crystallinity polypropylene copolymer with a melt index of 10 g/min measured at 230° C. and 21.2 N according to ISO 1133-1 was prepared.
co-HCPP B: Impact HCPP as a high crystallinity polypropylene copolymer with a melt index of 30 g/min measured at 230° C. and 21.2 N according to ISO 1133-1 was prepared.
ho-HCPP C: Homo HCPP as a high crystallinity polypropylene homopolymer with a melt index of 45 g/min measured at 230° C. and 21.2 N according to ISO 1133-1 was prepared.
ho-HCPP D: Homo HCPP as a high crystallinity polypropylene homopolymer with a melt index of 65 g/min measured at 230° C. and 21.2 N according to ISO 1133-1 was prepared.
co-HCPP E: Impact HCPP as a high crystallinity polypropylene copolymer with a melt index of 60 g/min measured at 230° C. and 21.2 N according to ISO 1133-1 was prepared.
POE A: A polyolefin elastomer as an impact modifier with a density of 0.86 g/cm³ and a melt index of 2 g/min measured at 230° C. and 21.2 N according to ISO 1133-1 was prepared.
POE B: A polyolefin elastomer as an impact modifier with a density of 0.88 g/cm³ and a melt index of 10 g/min measured at 230° C. and 21.2 N according to ISO 1133-1 was prepared.
Second filler: Talc (KOCH KCM6300) with an average particle size of 5.5 μm was prepared.

TABLE 1

| | Example | Example | Example | Comparative | Comparative | Comparative |
|---|---|---|---|---|---|---|
| Classification | 1 | 2 | 3 | Example 1 | Example 2 | Example 3 |
| Recycled PP | 20 | 50 | 20 | 100 | 70 | 70 |
| co-HCPP A | 22 | | 22 | | | |
| co-HCPP B | | 31.5 | | | | 15 |
| ho-HCPP C | 30 | | 18.5 | | 19 | |
| ho-HCPP D | | | | | | |
| co-HCPP E | | | 14 | | | |
| POE A | 9 | 5.5 | 6 | | | 4 |
| POE B | | | | | | |
| Second filler | 19 | 14 | 19.5 | | 11 | 11 |
| Total filler | 21.4 | 20 | 21.9 | 12 | 19.4 | 19.4 |
| HCPP/POE | 5.78 | 5.73 | 9.08 | | | 3.75 |

Unit: wt %, total filler: combined wt % of total filler (an inorganic material) based on composition
HCPP/POE: high crystallinity polypropylene/polyolefin elastomer weight ratio

TABLE 2

| | Comparative | Comparative | Comparative | Comparative | Comparative | Comparative |
|---|---|---|---|---|---|---|
| | Example | Example | Example | Example | Example | Example |
| Classification | 4 | 5 | 6 | 7 | 8 | 9 |
| Recycled PP | 20 | 40 | 20 | 20 | 20 | 20 |
| co-HCPP A | 20 | | | | 12 | 20 |
| co-HCPP B | 22 | | 45 | | 12 | 20 |
| ho-HCPP C | | 39.5 | | 49 | | 14 |
| ho-HCPP D | 11 | | 9.5 | | 25 | |
| co-HCPP E | | | | | | |
| POE A | 10 | 2 | 4.5 | | 8 | |
| POE B | | | | 14 | | |
| Second filler | 17 | 16 | 21 | 17 | 24 | 17 |
| Total filler | 19.4 | 20.8 | 23.4 | 19.4 | 26.4 | 19.4 |
| HCPP/POE | 5.3 | 19.75 | 12.11 | 3.5 | 6.13 | 3.18 |

Unit: wt %, total filler: combined wt % of total filler (an inorganic material) based on composition
HCPP/POE: high crystallinity polypropylene/polyolefin elastomer weight ratio

### Test Example—Measurement of Properties

The properties of the specimens manufactured in Examples and Comparative Examples were measured as follows, and the results thereof are shown in Tables 3 and 4 below.

Melt flow index (melt index (MI), melt flow rate (MFR)): Measurement was performed under conditions of 230° C. and 21.2 N (load) according to ISO 1133-1.

Density: Measurement was performed according to ISO 1183.

IZOD impact strength: Measurement was performed according to ISO 180 Type A. The size of a test piece was 80 mm*10 mm*4 mm, and a notched test piece was used.

Heat deflection temperature (HDT): Measurement was performed under conditions of 0.45 MPa according to ISO 75.

Tensile strength, elongation: Measurement was performed according to ISO 527 using ISO 3167 Type A as a test piece under conditions of 50 mm/min.

Flexural modulus, flexural strength: Measurement was performed according to ISO 178 using a test piece having a size of 80 mm*10 mm*4 mm and a span length of 64 mm at a test speed of 2 mm/min.

TABLE 3

| | Example | Example | Example | Comparative | Comparative | Comparative |
|---|---|---|---|---|---|---|
| Classification | 1 | 2 | 3 | Example 1 | Example 2 | Example 3 |
| MI | 9.9 | 10.5 | 10.1 | 10.5 | 9.1 | 9.1 |
| (g/min) | | | | | | |
| Density | 1.061 | 1.051 | 1.065 | 0.995 | 1.057 | 1.054 |
| (g/cm²) | | | | | | |
| Tensile | 28.7 | 27.2 | 27.1 | 19.5 | 26.8 | 27.2 |
| strength | | | | | | |
| (MPa) | | | | | | |
| Flexural | 45 | 42 | 41.9 | 28.5 | 41 | 41.8 |
| strength | | | | | | |
| (MPa) | | | | | | |
| Flexural | 2100 | 1980 | 2007 | 1367 | 2070 | 1983 |
| modulus | | | | | | |
| (MPa) | | | | | | |
| IZOD impact | 5.2 | 5.5 | 5.4 | 4.3 | 4.1 | 4.9 |
| strength | | | | | | |
| 23° C. (kJ/m²) | | | | | | |
| IZOD impact | 3.5 | 3.6 | 2.7 | 1.7 | 1.7 | 1.7 |
| strength | | | | | | |
| −13° C. (kJ/m²) | | | | | | |
| Heat deflection | 122.3 | 118.7 | 117.2 | 99.6 | 119.0 | 115.5 |
| temperature | | | | | | |
| (° C.) | | | | | | |

TABLE 4

| | Comparative | Comparative | Comparative | Comparative | Comparative | Comparative |
|---|---|---|---|---|---|---|
| Classification | Example 4 | Example 5 | Example 6 | Example 7 | Example 8 | Example 9 |
| MI | 12.8 | 13.7 | 19.2 | 16.8 | 10.0 | 11.2 |
| (g/min) | | | | | | |
| Density | 1.039 | 1.058 | 1.076 | 1.036 | 1.093 | 1.024 |
| (g/cm²) | | | | | | |
| Tensile | 24.6 | 29.4 | 24.4 | 25.0 | 30.0 | 25.3 |
| strength | | | | | | |
| (MPa) | | | | | | |
| Flexural | 38.7 | 43.1 | 37.2 | 37.4 | 42.5 | 37.9 |
| strength | | | | | | |
| (MPa) | | | | | | |
| Flexural | 1920 | 2325 | 2130 | 1937 | 2434 | 2057 |
| modulus | | | | | | |
| (MPa) | | | | | | |
| IZOD impact | 10.5 | 3.6 | 4.2 | 6.5 | 5.2 | 6.6 |
| strength | | | | | | |
| 23° C. (kJ/m²) | | | | | | |
| IZOD impact | 2.7 | 1.7 | 1.6 | 2.8 | 3.3 | 3.2 |
| strength | | | | | | |
| −13° C. | | | | | | |
| (kJ/m²) | | | | | | |
| Heat | 116.1 | 118.8 | 115.6 | 114.3 | 120.6 | 115.4 |
| deflection | | | | | | |
| temperature | | | | | | |
| (° C.) | | | | | | |

Referring thereto, Examples, including a predetermined amount of recycled polypropylene, satisfying a HCPP/POE weight ratio of 3 to 11, and having 20 wt % to 25 wt % of a total filler based on the total weight of the composition, showed results suitable for a radiator upper cover in all evaluation items of the properties and exhibited environmentally-friendly product characteristics.

In Comparative Example 1, the properties when 100 wt % of recycled polypropylene was applied were exhibited. Because recycled resin derived from end-of-life vehicles is contained therein, polypropylene materials with various specifications may be mixed, and the properties are lower than those required for a radiator upper cover due to aging and deterioration.

Comparative Example 2, including 70 wt % of recycled polypropylene, showed low IZOD impact strength of 1.7 KJ/m² at −10° C. even when the high crystallinity polypropylene homopolymer and the filler were mixed.

Comparative Example 3, including 70 wt % of recycled polypropylene, showed low IZOD impact strength at −10° C. and a low heat deflection temperature even when the high crystallinity polypropylene copolymer, the impact modifier, and the filler were mixed.

In Comparative Example 4, the combined amount of the inorganic material (first filler) in recycled polypropylene and the second filler was less than 20 wt % based on the total weight of the final composition, resulting in low strength, rigidity, and heat deflection temperature.

Comparative Example 5 had an HCPP/POE ratio of about 20.8 and Comparative Example 6 had an HCPP/POE ratio of about 12.1, showing that the proportion of polyolefin elastomer as an impact modifier was low, resulting in low IZOD impact strength at −10° C.

In Comparative Example 7, the combined amount of the inorganic material (first filler) in recycled polypropylene and the second filler was less than 20 wt % based on the total weight of the composition, resulting in low rigidity and heat deflection temperature.

In Comparative Example 8, the combined amount of the inorganic material (first filler) in recycled polypropylene and the second filler exceeded 25 wt % based on the total weight of the composition, increasing the total weight of a product, which is disadvantageous for fuel efficiency of a final product.

In Comparative Example 9, the combined amount of the inorganic material (first filler) in recycled polypropylene and the second filler was less than 20 wt % based on the total weight of the composition, resulting in low strength, rigidity, and heat deflection temperature.

Therefore, it was confirmed that the molded bodies of Comparative Examples were not suitable for the properties required for vehicle parts, particularly radiator upper covers.

According to the present disclosure, a composition for vehicle parts includes not only a predetermined proportion of recycled polypropylene but also high crystallinity polypropylene, an impact modifier, and a filler, and thus can minimize degradation of impact strength, heat resistance, moldability, and other mechanical properties and can be easily applied to vehicle parts.

The effects of the present disclosure are not limited to the above-mentioned effects. It should be understood that the effects of the present disclosure include all effects that can be inferred from the description of the present disclosure.

Although specific embodiments of the present disclosure have been described, those having ordinary skill in the art will appreciate that the present disclosure may be embodied in other specific forms without changing the technical spirit or essential features thereof. Thus, the embodiments described above should be understood to be non-limiting and illustrative in every way.

What is claimed is:

1. A composition for a vehicle part based on a recycled polypropylene, the composition comprising:
15 wt % to 55 wt % of the recycled polypropylene optionally containing a first filler; a high crystallinity polypropylene; an impact modifier; and a second filler,
wherein a weight ratio of the high crystallinity polypropylene to the impact modifier is in a range of 3:1 to 11:1,
wherein a combined weight of the first filler and the second filler is from 20 wt % to 25 wt % based on a total weight of the composition, and
wherein the recycled polypropylene has a melt index of from 5 g/10 min to 35 g/10 min measured at 230° C. and 21.2 N (load) according to ISO 1133-1.

2. The composition of claim 1, comprising:
30 wt % to 60 wt % of the high crystallinity polypropylene;
3 wt % to 15 wt % of the impact modifier; and
10 wt % to 25 wt % of the second filler.

3. The composition of claim 1, wherein:
the recycled polypropylene is derived from a vehicle waste comprising polypropylene, and
the vehicle waste comprises a door trim, instrument panel, pillar trim, cowl side, door scuff, wheel guard, rear cover, under cover, transverse trim, crash pad cover, steering column shroud, glove box, air duct, or a combination thereof.

4. The composition of claim 1, wherein the recycled polypropylene comprises the first filler in an amount of 24 wt % or less, but greater than 0 wt %.

5. The composition of claim 1, wherein the recycled polypropylene has:
a tensile strength in a range of 18 MPa to 23 MPa measured at 50 mm/min according to ISO 527,
a flexural modulus in a range of 1100 MPa to 1500 MPa measured at 2 mm/min according to ISO 178, and
an IZOD impact strength in a range of 1.0 KJ/m² to 1.8 KJ/m² measured at −10° C. according to ISO 180.

6. The composition of claim 1, wherein the high crystallinity polypropylene has a crystallinity of 50% or more, and comprises a high crystallinity polypropylene copolymer, a high crystallinity polypropylene homopolymer, or a combination thereof.

7. The composition of claim 6, wherein the high crystallinity polypropylene copolymer has:
a melt index in a range of 10 g/10 min to 110 g/10 min measured at 230° C. and 21.2 N according to ISO 1133-1,
a heat deflection temperature of 110° C. or higher measured under conditions of 0.45 MPa according to ISO 75, and
a flexural modulus in a range of 1600 MPa to 2200 MPa measured at 2 mm/min according to ISO 178.

8. The composition of claim 6, wherein the high crystallinity polypropylene homopolymer has:
a melt index in a range of 15 g/10 min to 70 g/10 min measured at 230° C. and 21.2 N according to ISO 1133-1,
a heat deflection temperature of 120° C. or higher measured under conditions of 0.45 MPa according to ISO 75, and
a flexural modulus in a range of 1800 MPa to 2300 MPa measured at 2 mm/min according to ISO 178.

9. The composition of claim 6, wherein the high crystallinity polypropylene comprises the high crystallinity polypropylene homopolymer and the high crystallinity polypropylene copolymer in a weight ratio of from 1:0.7 to 1:10.

10. The composition of claim 1, wherein:
the impact modifier comprises a polyolefin elastomer, and
the polyolefin elastomer has a density of from 0.85 g/cm³ to 0.89 g/cm³ and a melt index of from 0.5 g/10 min to 30 g/10 min measured at 230° C. and 21.2 N according to ISO 1133-1.

11. The composition of claim 1, wherein each of the first filler and the second filler comprises talc, silica, wollastonite, mica, calcium carbonate, barium sulfate, magnesium oxide, calcium silicate, or any combination thereof.

12. The composition of claim 1, wherein the composite has:
a tensile strength of 25 MPa or more measured at 50 mm/min according to ISO 527, and
a flexural modulus of 1800 MPa or more measured at 2 mm/min according to ISO 178.

13. The composition of claim 1, wherein the composition has a density in a range of 1.03 g/cm³ to 1.09 g/cm³.

14. A molded body comprising: a composition for a vehicle part, wherein the composition comprises:
15 wt % to 55 wt % of a recycled polypropylene optionally containing a first filler, a high crystallinity polypropylene, an impact modifier, and a second filler,
wherein:
a weight ratio of the high crystallinity polypropylene to the impact modifier is in a range of 3:1 to 11:1,
a combined weight of the first filler and the second filler is from 20 wt % to 25 wt % based on a total weight of the composition, and
the recycled polypropylene has a melt index of from 5 g/10 min to 35 g/10 min measured at 230° C. and 21.2 N (load) according to ISO 1133-1.

15. The molded body of claim 14, which is applied to a radiator upper cover for a vehicle.
